(19) United States
(12) Patent Application Publication
(10) Pub. No.: US 2018/0373390 A1
(43) Pub. Date: Dec. 27, 2018

(54) TOUCH INPUT APPARATUS

(71) Applicant: FUJITSU CONNECTED TECHNOLOGIES LIMITED, Kawasaki-shi (JP)

(72) Inventor: Youichi Kondou, Kawasaki (JP)

(73) Assignee: FUJITSU CONNECTED TECHNOLOGIES LIMITED, Kawasaki-shi (JP)

(21) Appl. No.: 16/120,883

(22) Filed: Sep. 4, 2018

Related U.S. Application Data
(63) Continuation of application No. PCT/JP2016/056899, filed on Mar. 4, 2016.

(51) Int. Cl. G06F 3/041; G06F 3/044

(52) U.S. Cl. CPC G06F 3/0418; G06F 3/045; G06F 3/044

(57) ABSTRACT

A touch input apparatus includes a touch panel, a memory, and a processor. The processor is coupled to the memory. The processor is configured to perform determining an input operation is made when a detection value of the touch panel exceeds a predetermined threshold value, acquiring an attitude information indicating a attitude state of a self apparatus, and decreasing the predetermined threshold value when the attitude information varies concomitantly with a increase in the detection value.

### CROSS-REFERENCE TO RELATED APPLICATION

This application is a continuation application of International Application PCT/JP2016/056899 filed on Mar. 4, 2016 and designated the U.S., the entire contents of which are incorporated herein by reference.

### FIELD

The embodiments discussed herein are related to a touch input apparatus.

### BACKGROUND

Some of electronic equipments each having a touch panel as instanced by a mobile phone and a smartphone have hitherto been configured to accept a touch operation of touching a touch panel and a pressing operation of pressing the touch panel as input operations.

### DOCUMENTS OF RELATED ARTS

### Patent Documents

[Patent Document 1] Japanese Laid-open Patent Publication No. 2012-27875
[Patent Document 2] Japanese Laid-open Patent Publication No. 2013-80999
[Patent Document 3] Japanese Laid-open Patent Publication No. 2013-54513

### SUMMARY

According to an aspect of the embodiments, a touch input apparatus includes a touch panel, a memory, and a processor. The processor is coupled to the memory. The processor is configured to determining an input operation is made when a detection value of the touch panel exceeds a predetermined threshold value, acquiring an attitude information indicating a attitude state of a self apparatus, and decreasing the predetermined threshold value when the attitude information varies concomitantly with a increase in the detection value.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a block diagram illustrating a configuration of a touch input apparatus according to an embodiment;

FIG. 2 is an explanatory view for explaining an input operation on a touch panel;

FIGS. 3A and 3B are explanatory diagrams for explaining variations, caused by a pressing force, in attitude of the touch input apparatus;

FIG. 4 is an explanatory view for explaining a variation on a contact surface;

FIG. 5 is a flowchart illustrating an operation of the touch input apparatus according to the embodiment;

FIG. 6 is an explanatory diagram for explaining a scan timing;

FIG. 7 is an explanatory diagram for explaining an instance of obtaining correction values of other coordinates from the correction values of plural sets of coordinates; and

FIG. 8 is a flowchart illustrating how the correction value is calculated.

### DESCRIPTION OF EMBODIMENTS

In the input operation on the touch panel, such a problem arises that operability is impaired due to a variation of degree of a force applied to the input operation when an operating position shifts on the touch panel, depending on a retaining state of the apparatus.

One example is that in a state of uniformly retaining a back surface of the apparatus, the force applied by the user in any position on the touch panel is uniformly propagated to the touch panel, and it is therefore feasible to perform the input operation by the same degree of force. However, a screen of a display panel is enlarged, and, when the apparatus is upsized, it is difficult to uniformly retain the apparatus as the case may be.

For example, in the state of retaining an upper portion of the back surface of the apparatus, an attitude of the apparatus gets easier to vary in a case of pressing a lower position on the touch panel than a case of pressing an upper position on the touch panel. The variation in attitude of the apparatus brings about a dispersion of the force of pressing the touch panel, and hence there is a difference caused in the degree of force (pressing force) till detecting the input operation in the operating position on the touch panel. For example, it follows that a much larger pressing force is applied till detecting the input operation in the case of pressing the lower position on the touch panel than the case of pressing the upper position on the touch panel. A scatter in the degree of force per operating position when performing the input operation on the touch panel leads to a discomfortable feeling of the operation.

A touch input apparatus according to an embodiment will hereinafter be described with reference to the drawings. In the embodiment, components having the same functions are marked with the same numerals and symbols, and repetitive explanations thereof are omitted. Note that the touch input apparatus to be described in the following embodiment is merely one example but does not limit the embodiment. Embodiments given below may be properly combined within an uncontradictory range.

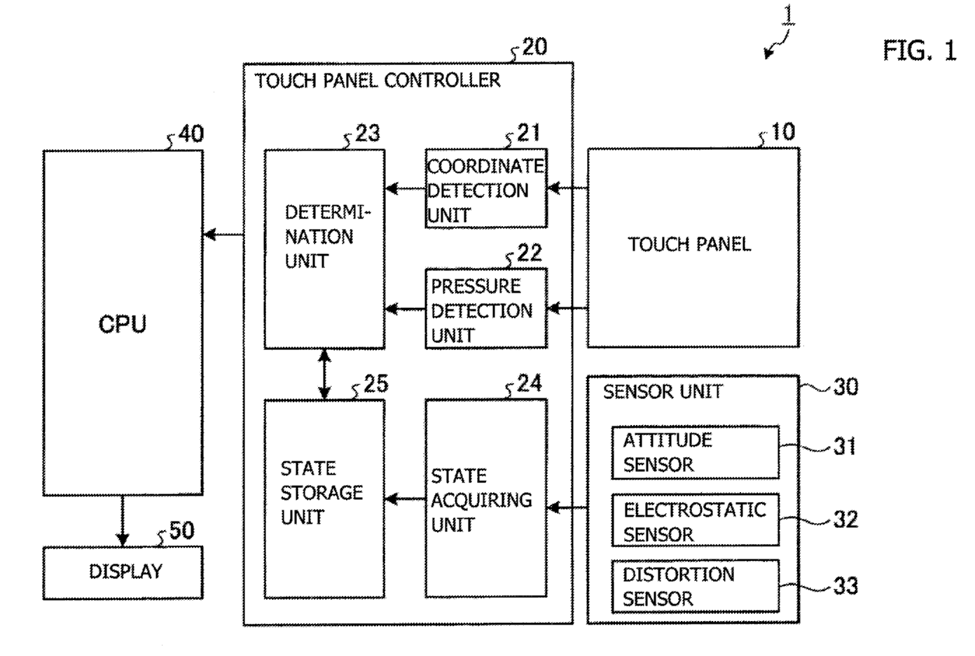

FIG. 1 is a block diagram illustrating a configuration of the touch input apparatus according to the embodiment. As illustrated in FIG. 1, a touch input apparatus 1 is an electronic equipment instanced by a mobile phone and a smartphone including a touch panel 10. The touch input apparatus 1 includes the touch panel 10, a touch panel controller 20, a sensor unit 30, a Central Processing Unit (CPU) 40 and a display 50.

The touch panel 10 is a touch panel of, e.g., an electrostatic capacitance type, in which an electrode film is pasted to a surface. When a user's finger touches the surface of the touch panel 10, the touch panel 10 detects a variation in electrostatic capacitance generated between a finger tip and the electrode film, and outputs a detection value to the touch panel controller 20. The touch panel controller 20 detects touch coordinates in which the user conducts an input operation, based on coordinates in which to cause the variation in electrostatic capacitance on the touch panel 10.

In the touch coordinates on the touch panel 10, a flexure corresponding to a pressing force by which the user's finger presses the surface of the touch panel 10 occurs. For example, a larger flexure occurs as the pressing force becomes larger. This flexure, which occurs corresponding to the pressing force, is detected as a difference of the electrostatic capacitance on the touch panel 10. The touch panel controller 20 detects the pressing force by which the user presses the surface upon performing the input operation, based on the difference (differential) of the electrostatic capacitance generated in the touch coordinates.

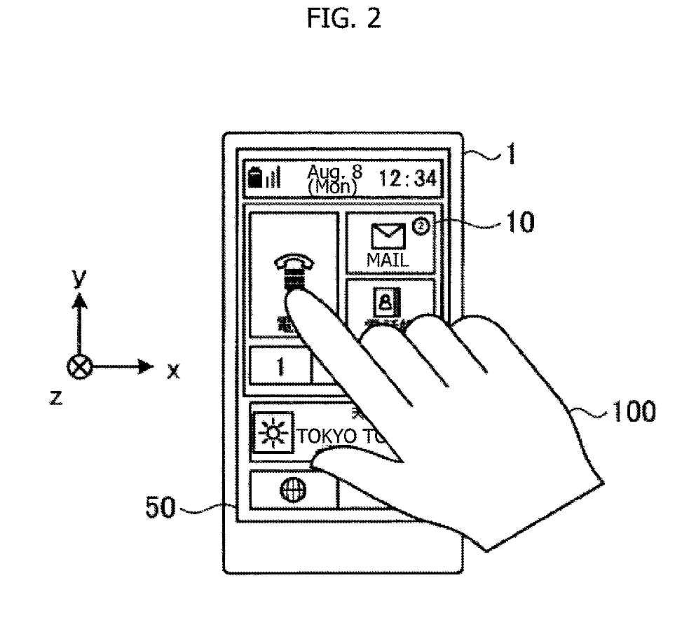

FIG. 2 is an explanatory view for explaining the input operation on the touch panel 10. Note that a crosswise direction and a vertical direction on the surface of the touch input apparatus 1 are defined as an x-direction and a y-direction in FIG. 2. A direction orthogonal to the x- and y-directions and extending to an undersurface from the surface of the touch input apparatus 1, is defined as a z-direction. As depicted in FIG. 2, e.g., the touch panel 10 is provided in superposition over the display 50 on the surface of the touch input apparatus 1. The touch panel 10 detects x- and y-directional touch coordinates (of a position) touched by a hand 100 of the user. The touch panel 10 also detects a pressing force generated when the user's hand 100 presses the touch panel 10 in the z-direction in the touch coordinates.

Note that a detection method of the touch panel 10 is not limited to the electrostatic capacitance method described above, but may include any types of methods capable of detecting the touch coordinates and the pressing force. For example, a resistive film method may be adopted as a method different from the electrostatic capacitance method.

The touch panel controller 20 is a device that controls the touch panel 10. To be specific, the touch panel controller 20 includes a coordinate detection unit 21, a pressure detection unit 22, and a determination unit 23. The coordinate detection unit 21 detects, based on the detection value of the touch panel 10, coordinates in which the variation in electrostatic capacitance occurs, and outputs the detected coordinates to the determination unit 23. The pressure detection unit 22 detects, based on a difference of the electrostatic capacitance, a pressing force applied onto the touch panel 10, and outputs the detected pressing force to the determination unit 23.

The determination unit 23 determines, based on the output of the coordinate detection unit 21, the touch coordinates in which the user touches the touch panel 10, and outputs a determination result to the CPU 40. When the pressing force detected by the pressure detection unit 22 exceeds a predetermined threshold value (detection threshold value), the determination unit 23 determines that a pressing operation is made, and outputs the determination result to the CPU 40.

With respect to this detection threshold value, a value serving as an initial value is to be preset in the memory within the touch panel controller 20. Further with respect to the detection threshold value, a correction quantity for correcting a value of the detection threshold value is set per coordinate on the touch panel 10. Accordingly, on the occasion of determining the pressing operation, the determination unit 23 reads, from the memory, the correction quantity corresponding to the coordinates (touch coordinates) to which the pressing force is applied, and makes a determination based on a post-correcting detection threshold value.

Note that various items of information (e.g., the measurement result) per coordinate on the touch panel 10 in addition to the foregoing detection threshold value and the correction quantity per coordinate on the touch panel 10 are stored in the memory within the touch panel controller 20.

The sensor unit 30 detects an attitude state of the touch input apparatus 1, and outputs a detection result to the touch panel controller 20. The attitude state of the touch input apparatus 1, which is detected by the sensor unit 30, may be any of states indicating a varying state of the touch input apparatus 1 when the user performs the input operation on the touch panel 10, as instanced by an attitude of the touch input apparatus 1 and a holding state when the user employs the touch input apparatus 1 by directly holding the touch input apparatus 1. Specifically, the sensor unit 30 includes an attitude sensor 31, an electrostatic sensor 32 and a distortion sensor 33.

The attitude sensor 31 is, e.g., a triaxial gyro sensor, and detects the attitude of the touch input apparatus 1. The electrostatic sensor 32 is provided, e.g., on a back surface of the touch input apparatus 1, and detects a contact position of the user on the back surface. The distortion sensor 33 is installed on an outer peripheral surface of a housing of the touch input apparatus 1, and detects a distortion corresponding to the holding force applied by the user when holding (grasping) the touch input apparatus 1.

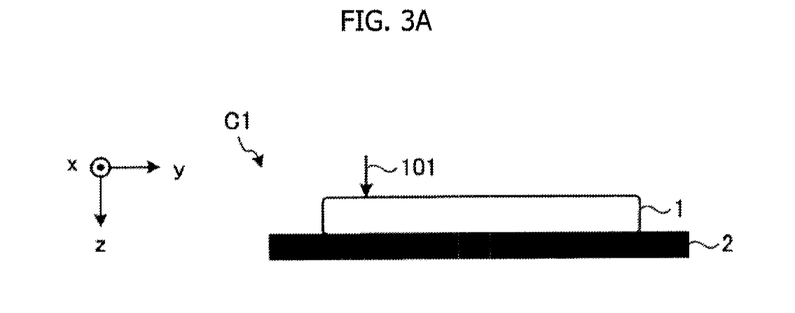

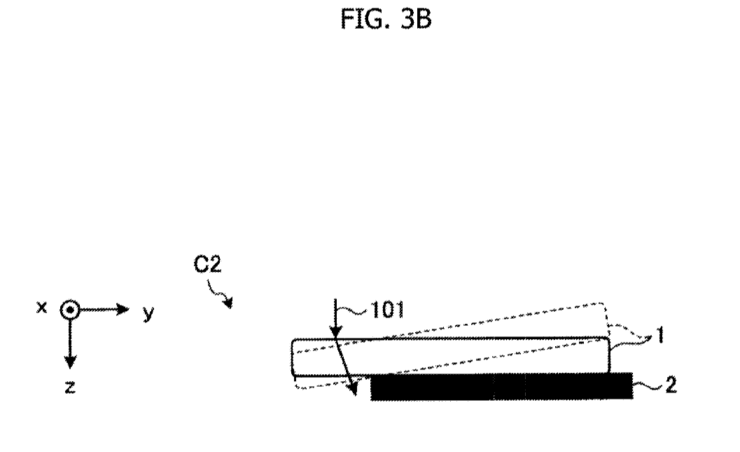

FIGS. 3A and 3B are explanatory diagrams for explaining variations, caused by a pressing force 101, in attitude of the touch input apparatus 1. In a state C1 of FIG. 3A, the touch input apparatus 1 is held on a base plate 2 in contact with the whole back surface of the touch input apparatus 1. In a state C2 of FIG. 3B, the touch input apparatus 1 is held by an upper portion of the base plate 2 from the vicinity of a center of the back surface of the touch input apparatus 1.

As illustrated in FIGS. 3A and 3B, in the state C1, any variation does not occur in attitude of the touch input apparatus 1 even when the pressing force 101 is applied in the z-direction through the input operation on a lower portion of the touch panel 10. By contrast, in the state C2, when the pressing force 101 is applied in the z-direction through the input operation on the lower portion of the touch panel 10, the attitude of the touch input apparatus 1 varies. The attitude sensor 31 detects the attitude of the touch input apparatus 1, which varies through the input operation on the touch panel 10.

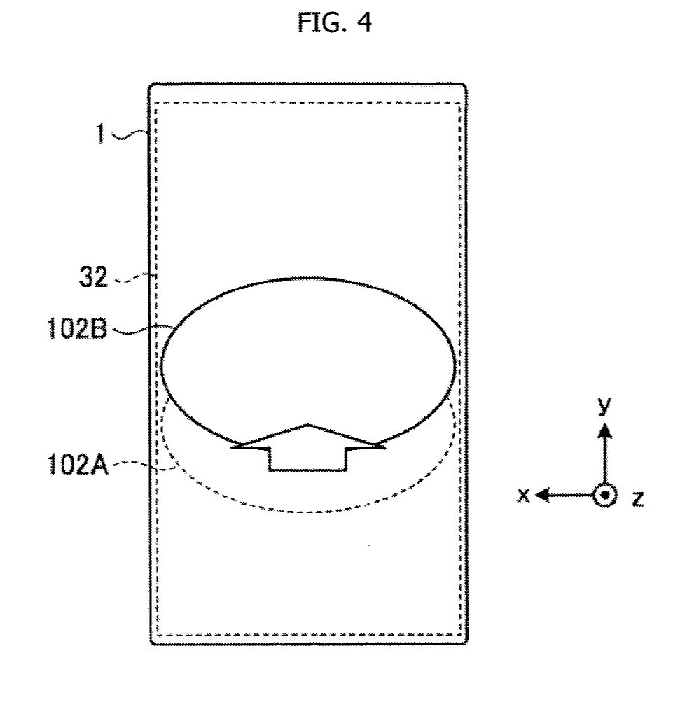

FIG. 4 is an explanatory view for explaining a variation on a contact surface. As depicted in FIG. 4, the back surface of the touch input apparatus 1 is provided with the electrostatic sensor 32 that detects the contact position (contact surface) when, e.g., the user holds the touch input apparatus 1 by hand. When the user grasps the touch input apparatus 1 by hand and when the attitude of the touch input apparatus 1 varies by the pressing force 101 through the input operation on the touch panel 10, the hand contact surface detected by the electrostatic sensor 32 varies like this: 102A->102B. The contact surface shifts upwards such as 102A->102B, in which case it may be grasped that an upper side of the touch input apparatus 1 gets inclined in attitude thereof toward the back surface (z-direction) by the pressing force 101 through the input operation on the upper portion of the touch panel 10.

When the attitude of the touch input apparatus 1 varies while the user grasps the touch input apparatus 1 by hand, the user increases a holding force applied to the touch input apparatus 1 so as to restrain the variation in attitude. It is therefore feasible for the touch input apparatus 1 to detect the variation in attitude of the touch input apparatus 1 through the input operation on the touch panel 10 on the basis of the detection result of the distortion sensor 33.

Incidentally, it may be sufficient that the sensor unit 30 has at least one of, e.g., the attitude sensor 31, the electrostatic sensor 32 and the distortion sensor 33 as the sensor for detecting the variation in attitude of the touch input apparatus 1 through the foregoing input operation on the touch panel 10.

The touch panel controller 20 decreases, based on the detection result of the sensor unit 30, the detection threshold value related to the determination of the input operation on the basis of the detection value given from the touch panel 10 when the variation occurs in the attitude state of the touch input apparatus 1 concomitantly with a rise in pressing force 101.

Specifically, the touch panel controller 20 includes a state acquiring unit 24 and a state storage unit 25. The state acquiring unit 24 acquires the detection result of the sensor unit 30 in synchronization with a timing of scanning the the touch coordinates on the touch panel 10 and the pressing force 101. The state storage unit 25 sequentially stores the detection results of the sensor unit 30, which are acquired by the state acquiring unit 24, i.e., information (attitude information) indicating the attitude states of the touch input apparatus 1 at every scan timing.

The determination unit 23 acquires the variation in attitude state of the touch input apparatus 1, the variation being concomitant with the increase in the pressing force 101, by referring to the attitude information stored in the state acquiring unit 24. When the variation in attitude state of the touch input apparatus 1 occurs concomitantly with the increase in the pressing force 101, the determination unit 23 decreases the detection threshold value for determining that the pressing operation is made.

This operation enables the touch input apparatus 1 to determine that the pressing operation is made by the pressing force 101 weaker than a non-variation case of the attitude when the attitude of the touch input apparatus 1 varies upon applying the pressing force 101. The touch input apparatus 1 is therefore enabled to inhibit impairment of operability by restraining a scatter in degree of the force till determining that the operation is made, the scatter being caused due to the variation in attitude when performing the input operation on the touch panel 10.

The CPU 40 controls the operation of the touch input apparatus 1 by sequentially running the program. The display 50 is a display device instanced by a Liquid Crystal Display (LCD). The display 50 accepts various items of information outputted by the CPU 40, and displays the accepted information. For example, the CPU 40 executes processes corresponding to the touch coordinates, notified from the touch panel controller 20, on the touch panel 10 and the determination result that the pressing operation is made, and causes the display 50 to display the information of the processing result.

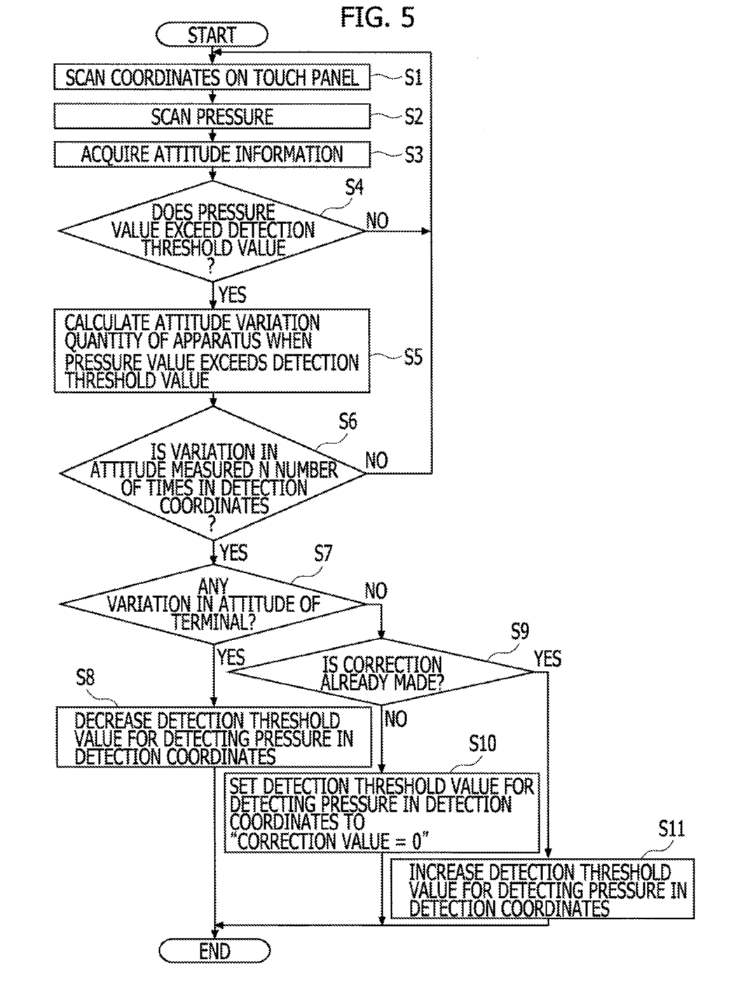

Herein, an in-depth description of a process of adjusting the detection threshold value related to the input operation on the touch panel 10 will be made. FIG. 5 is a flowchart illustrating an operation of the touch input apparatus according to the embodiment.

As illustrated in FIG. 5, upon a start of processing, the coordinate detection unit 21 scans the electrostatic capacitance of the touch panel 10 at a predetermined timing (e.g., at an interval of several tens of milliseconds) (S1). The determination unit 23 notifies the CPU 40 of coordinates in which the electrostatic capacitance varies as touch coordinates, based on a scan result of the coordinate detection unit 21.

Next, the pressure detection unit 22 scans the pressing force 101 applied onto the touch panel 10, based on a difference between the electrostatic capacitances (S2). Subsequently, the state acquiring unit 24 acquires the information (attitude information) indicating the attitude state of the touch input apparatus 1 from the sensor unit 30 (S3). The state acquiring unit 24 stores the acquired attitude information in the state storage unit 25.

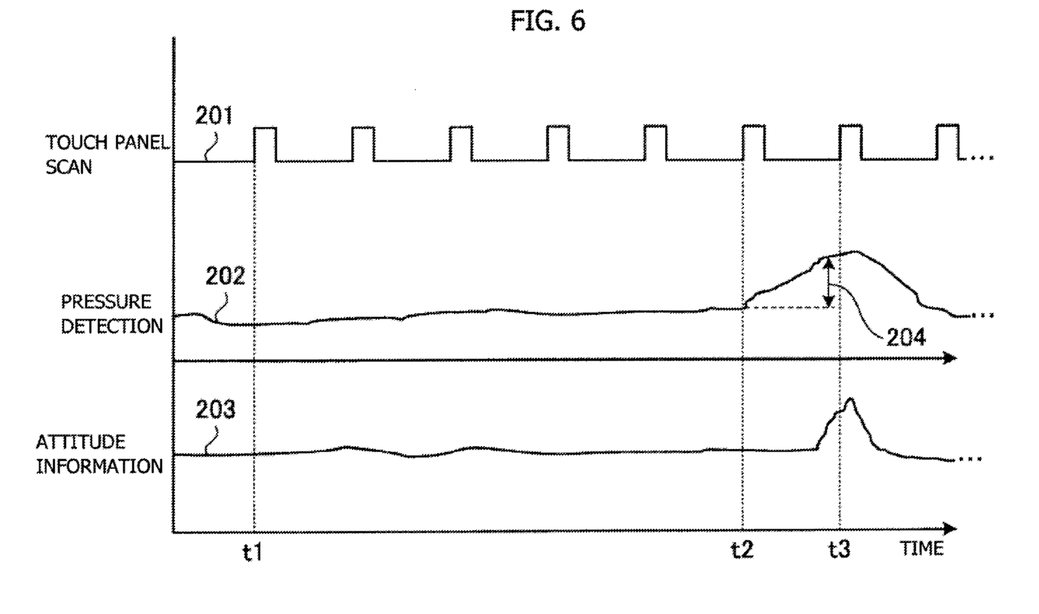

FIG. 6 is an explanatory diagram for explaining the scan timing. As illustrated in FIG. 6, in the touch input apparatus 1, a pressure detection 202 of the touch panel 10 and attitude information 203 of the touch input apparatus 1 are acquired corresponding to a timing (a rising portion of a waveform) of a touch panel scan 201 for detecting the touch coordinates. For example, the pressure detection 202 and the attitude information 203 are acquired at timings of times t2-t3. Incidentally, it is assumed that the execution of the pressing operation on the touch panel 10 is underway during a period of times t2-t3, and that the detection value of the pressure detection 202 at the time t3 exceeds the detection threshold value.

Subsequently, the determination unit 23 determines whether the pressure value of the pressing force 101 exceeds the detection threshold value (S4). When the pressure value of the pressing force 101 does not exceed the detection threshold value (S4: NO), the determination unit 23 loops back the processing to S1. For example, in the example of the times t1, t2 in FIG. 6, the detection value of the pressure detection 202 does not exceed the detection threshold value, and hence a negative (NO) determination is made in S4.

Whereas when the pressure value of the pressing force 101 exceeds the detection threshold value (S4: YES), the determination unit 23 refers to the attitude information stored in the state storage unit 25, and calculates an attitude variation quantity of the touch input apparatus 1 just when the pressure value of the pressing force 101 exceeds the detection threshold value (S5). Specifically, the determination unit 23 obtains, as the attitude variation quantity of the touch input apparatus 1, a difference between the immediate attitude information stored in the state storage unit 25 and the attitude information of this time when the pressure value of the pressing force 101 exceeds the detection threshold value.

For instance, in the example of the times t2, t3 in FIG. 6, at the time t3 when the pressure value of the pressing force 101 exceeds the detection threshold value, a difference 204 between the attitude information 203 at the time t3 and the immediate time t2 is obtained as the attitude variation quantity of the touch input apparatus 1.

Subsequently, the determination unit 23 refers to the information per coordinate of the touch panel 10, which is stored in the memory within the touch panel controller 20, and thus determines whether an attitude variation is measured a predetermined number of times (N times) in the detection coordinates (touch coordinates) when the pressure value of the pressing force 101 exceeds the detection threshold value (S6).

An arbitrary number is to be preset as “N” in S6. For example, a value other than “0” is set as “N”, in which case the attitude variation is checked N times in S6.

When the attitude variation is not measured N times in the detection coordinates (S6: NO), the determination unit 23 loops back the processing to S1. Whereas when the attitude variation is measured N times in the detection coordinates (S6: YES), the determination unit 23 determines, based on the attitude variation quantity obtained in S5, whether the attitude variation of the terminal (touch input apparatus 1) occurs (S7). To be specific, when the attitude variation quantity obtained in S5 is equal to or larger than a predetermined threshold value, the determination unit 23 determines that the attitude variation of the terminal occurs.

When the attitude variation of the terminal occurs (S7: YES), the determination unit 23 stores information representing that the attitude variation is measured in the detection coordinates in the memory within the touch panel controller 20 to store the various items of information per coordinate of the touch panel 10. For example, the determination unit 23 counts up a value of the number of times (N) indicating that the attitude variation is measured.

Successively, the determination unit 23 decreases the detection threshold value representing that the pressure is detected in the detection coordinates, i.e., that the pressing operation is made (S8). To be specific, the determination unit 23 sets a correction quantity for decreasing the detection threshold value in the detection coordinates with respect to the correction quantity per coordinate on the touch panel 10 in the memory within the touch panel controller 20. This correction quantity is to be a value corresponding to, e.g., the attitude variation quantity obtained in S5, and is to be a value for further decreasing the detection threshold value by setting the correction quantity larger as the attitude variation quantity becomes larger.

When the attitude variation of the terminal does not occur (S7: NO), the determination unit 23 refers to the correction quantity per coordinate on the touch panel 10 in the memory within the touch panel controller 20, and thus determines whether the detection threshold value is already corrected in the detection coordinates (S9).

When the correction quantity is not set and when the detection threshold value is not corrected in the detection coordinates (S9: NO), the determination unit 23 sets the detection threshold value for detecting the pressure in the detection coordinates such as the correction quantity=0 (S10). With this setting, when the attitude variation of the terminal does not occur and when the detection threshold value is not corrected, the correction value is set to “0” (correction value=0), while the detection threshold value remains to be the initial value.

When the correction quantity is set and when the detection threshold value is already corrected in the detection coordinates (S9: YES), the determination unit 23 increases the detection threshold value for detecting the pressure in the detection coordinates (S11).

To be specific, with respect to the detection coordinates, the determination unit 23 sets the correction quantity in such a direction as to return to the original detection threshold value, though the correction quantity for decreasing the detection threshold value depending on the attitude variation of the terminal is set so far. For example, the determination unit 23 changes the already-set value of the correction quantity for decreasing the detection threshold value to a much smaller value or such as the correction value=0. This setting enables the correction to return to the original, though conducting so far the correction for decreasing the detection threshold value because the attitude variation of the terminal occurs when performing the previous pressing operation in the case of no occurrence of the attitude variation of the terminal with respect to the pressing operation in the detection coordinates.

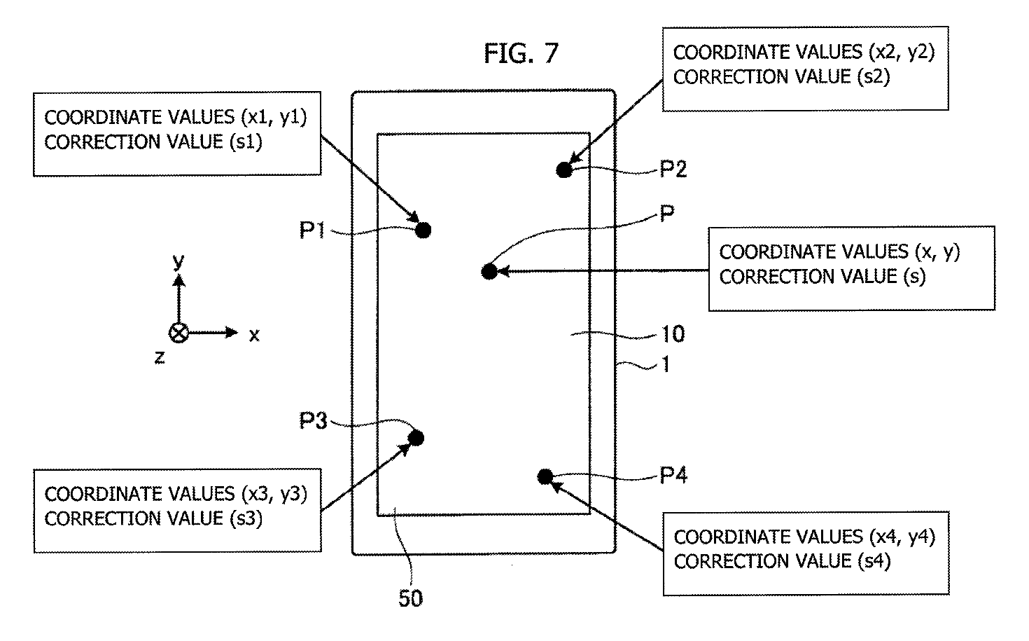

Note that with respect to the correction quantity of the detection threshold value per coordinate on the touch panel 10, the determination unit 23 may obtain the correction quantity in predetermined coordinates on the basis of correction quantities of other plural sets of coordinates. FIG. 7 is an explanatory diagram for explaining an instance of obtaining the correction value in the predetermined coordinates, based on the correction values of the plural sets of coordinates

In FIG. 7, a coordinate P having coordinate values (x, y) is defined as a coordinate for obtaining a correction value (s). Coordinates P1-P4 having coordinate values (x1, y1), (x2, y2), (x3, y3), (x4, y4) are to be coordinates that are already corrected by correction values (s1)-(s4).

The determination unit 23 extracts coordinates of at least two points in the already-corrected coordinates when obtaining the correction value (s) of the coordinate P. For example, the determination unit 23 extracts the coordinates P1, P2 in a sequence from closest distance to the coordinate P. Subsequently, the determination unit 23 calculates the correction value (s) of the coordinate P, based on the extracted two points (P1, P2), a distance from the coordinate P and the correction values (s1, s2) at the two points.

For instance, let a distance between the coordinates P and P1 be d1 and a distance between the coordinates P and P2 be d2, and the correction value (s) can be calculated by s=(s1*d2+s2*d1)/(d1+d2).

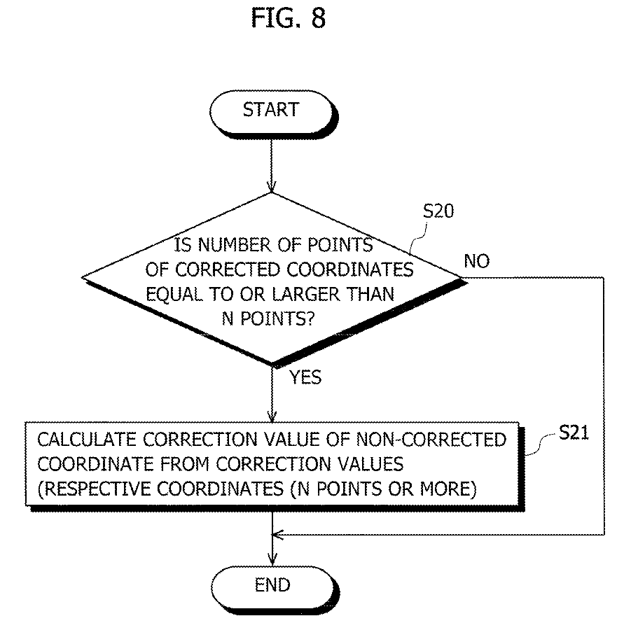

FIG. 8 is a flowchart illustrating how the correction value is calculated. Note that a start timing of the process of calculating the correction value illustrated in FIG. 8 may be triggered by making a new correction for a certain coordinate, and may also be periodically set by a timer and other equivalent devices. Alternatively, the start of the process may also be triggered at a timing (S8 or S11 illustrated in FIG. 5) for making the correction by the user's applying the pressing force 101 onto a certain coordinate.

As depicted in FIG. 8, upon starting the process, the determination unit 23 refers to the correction quantity per coordinate on the touch panel 10 in the memory within the touch panel controller 20, and thus determines whether a number of points of the corrected coordinate is equal to or larger than a predetermined number of points (N points) (S20). Note that an N's value is to satisfy N≥2. When equal to or larger than the predetermined number of points (S20: YES), the determination unit 23 calculates the correction value of the non-corrected coordinate from the correction value of each of the coordinates (equal to or larger than N points) (S21). The calculated correction value is stored per coordinate in the memory within the touch panel controller 20.

As described above, the touch input apparatus 1 includes the determination unit 23 determining that the input operation is made when the detection value of the touch panel 10 exceeds the predetermined threshold value. The touch input apparatus 1 further includes the state acquiring unit 24 acquiring the attitude state of the self apparatus from the determination unit 23. The determination unit 23 decreases the value of the detection threshold value related to determining that the input operation is made when the attitude state of the touch input apparatus 1 occurs concomitantly with the rise in detection value of the touch panel 10.

This configuration enables the touch input apparatus 1 to determine that the operation is made by the degree of the force weaker than the non-variation case of the attitude when the attitude of the touch input apparatus 1 varies concomitantly with the increase in detection value of the touch panel 10. The touch input apparatus 1 is therefore enabled to inhibit the impairment of the operability by restraining the scatter in degree of the force till determining that the operation is made, the scatter being caused due to the variation in attitude when performing the input operation on the touch panel 10.

The touch input apparatus 1 includes the coordinate detection unit 21 that detects the coordinate position touched by the user on the touch panel 10, and the pressure detection unit 22 that detects the pressing force 101 by which the user presses the touch panel 10. When the attitude state varies concomitantly with the increase in detection value related to the pressing force 101 in every detected coordinate position (S7: YES), the determination unit 23 decreases the value of the detection threshold value related to the determination about the pressing operation (S8). Accordingly, the touch input apparatus 1 is enabled to inhibit the impairment of the operability by restraining the scatter in degree of the force per operating position when performing the operation of pressing the touch panel.

Note that the respective components of the illustrated touch input apparatus 1 might not be physically configured as illustrated. Specific modes of dispersing/integrating the respective devices (components) are not limited to the illustrated mode, and a whole or a part of the components may be configured by being dispersed/integrated physically or functionally on an arbitrary unit basis, corresponding to a variety of loads and usage conditions.

For example, the touch panel controller 20 and the CPU 40 are integrated together, and the CPU 40 may provide the function as the touch panel controller 20. In this case, the CPU 40 runs a program, thereby providing functions as the coordinate detection unit 21, the pressure detection unit 22, the determination unit 23 and the state acquiring unit 24.

Note that the program run by the CPU 40 might not be stored in the storage device of the touch input apparatus 1. For example, the program stored on a non-transitory storage medium readable by the touch input apparatus 1 may be read and run. The storage medium readable by the touch input apparatus 1 corresponds to a portable recording medium instanced by a CD-ROM, a DVD disc and a USB (Universal Serial Bus) memory, a semiconductor memory instanced by a flash memory, and a hard disk drive. This program is stored in a device connected to a public circuit, the Internet, a LAN and other equivalent networks, and the touch input apparatus 1 may read the program from this device and may run the program.

According to one embodiment, it is feasible to inhibit the impairment of the operability of the touch panel.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A touch input apparatus comprising:
a touch panel;
a memory; and
a processor coupled to the memory and the processor configured to perform:
determining an input operation is made when a detection value of the touch panel exceeds a predetermined threshold value;
acquiring an attitude information indicating a attitude state of a self apparatus, and
decreasing the predetermined threshold value when the attitude information varies concomitantly with a increase in the detection value.

2. The touch input apparatus according to claim 1, wherein the processor further performs:
detecting a coordinate position touched by a user on the touch panel; and
detecting a pressing force by which the user presses the touch panel,
decreasing the predetermined threshold value related to a determination about an input operation derived from the user's pressing the touch panel when the attitude information varies concomitantly with the increase in detection value related to the pressing force in every detected coordinate position.

3. The touch input apparatus according to claim 2, wherein the processor further obtains a correction quantity when decreasing the predetermined threshold value in a predetermined coordinate position, based on at least two coordinate positions in a plurality of coordinate positions with the predetermined threshold value being lowered under a predetermine value, and based on the correction quantity for decreasing the predetermined threshold value in at least the two coordinate positions.

4. The touch input apparatus according to claim 1, wherein the memory stores the acquired attitude information,
wherein the processor obtains a variation in attitude information, based on a difference between the attitude information stored before the detection value exceeds the predetermined threshold value, and based on the attitude information stored when exceeding the predetermined threshold value.

5. The touch input apparatus according to claim 1, wherein the processor increases the value of the predetermined threshold value when the attitude information does not vary concomitantly with the increase in detection value and when the predetermined threshold value is lowered under the predetermined value.

6. The touch input apparatus according to claim 1, wherein the processor acquires a detection value of at least one of an attitude sensor to detect an attitude of the self apparatus as the attitude information, a contact sensor to detect a contact position between the user and the self apparatus, and a distortion sensor to detect a retaining force by which the user retains the self apparatus.
